(19) United States
(12) Patent Application Publication
(10) Pub. No.: US 2004/0179041 A1
(43) Pub. Date: Sep. 16, 2004

(54) METHOD FOR DEFINING FUNCTIONS OF KEYS OF A KEYPAD OF AN ELECTRONIC DEVICE

(76) Inventor: Swee-Koon Fam, Sandiago, CA (US)

Correspondence Address: NAIPO (NORTH AMERICA INTERNATIONAL PATENT OFFICE), P.O. BOX 506, MERRIFIELD, VA, 22116, US

(21) Appl. No.: 10/249,081

(22) Filed: Mar. 14, 2003

(51) Int. Cl. G09G 5/00

(52) U.S. Cl. 345/826; 345/864

(57) ABSTRACT

A method includes storing a standard keypad definition and at least one alternate keypad definition in a memory of a mobile phone. The standard and alternate keypad definitions correspond each key of the keypad to different key codes. A state of a Boolean flag stored in the memory and a keypad driver determine the keypad definition used by an application. The state of the flag can be set with the application. The keypad definition can be toggled between the standard and alternate definitions to realize extended or specialized input functionality with a standard 12-key telephone keypad.

### BACKGROUND OF INVENTION

1. Field of the Invention

The present invention relates to digital electronics, and more specifically, to a method of defining functions of keys of a keypad used in a digital electronic device, such as a mobile phone.

2. Description of the Prior Art

Handheld devices such as mobile phones and personal digital assistants (PDAs) are becoming increasingly popular with all types of consumers. As a result, demand for applications for these devices is increasing rapidly and technology struggles to keep pace.

Handheld device input methods have always been limited by the size of the device. That is, an input method needs to be well adapted for use by human hands on a relatively small device. Full alphanumeric keyboards, in particular, are difficult to provide on small handheld devices. As many software applications for handheld devices, such as business applications and word processors, require or a least work better with a standard keyboard, it is of interest to provide a solution. For example, a typical mobile phone has between 12 and 16 keys; the basic alphanumeric keys (0-9, abc) and several specialized keys (send, end, clear, etc.). However, an English language text messaging application requires a device able to generate at least 26 letters, plus numbers and additional symbols.

Conventional solutions to this input problem include mini-keyboards, foldable keyboards, handwriting recognition, and the multiple key press input method. Mini-keyboards are small enough to match the portability of the device, by have extremely tiny keys that are difficult for most people to actuate properly. In contrast, foldable keyboards provide larger and more ergonomic keys, but are cumbersome and not very robust. Additionally, both the mini and foldable keyboard solutions constitute additional pieces of hardware that must be supported in hardware. Handwriting recognition systems involve using a stylus to write onto a touch screen or stylus-sensitive writing pad, and having the device interpret touch signals. This approach is typically used in PDAs, where a large LCD screen or other flat writing surface is available. While handwriting recognition does have advantages, such as intuitiveness, in can be prone to errors and is generally limited to entering one character or letter at a time. Lastly, the multiple key press input method encodes a large number of characters into repetitive key presses of a relatively few amount of keys. For example, by pressing the “2” key three times the letter “c” can be input. The multiple key press input method is commonly used in mobile phones to enter a string of text with the ubiquitous 12-key alphanumeric keypad. This method can be time consuming and inconvenient because of the repetitive key presses required, and is not adaptable to higher level input as a more complex input requires an increasing number of key presses.

Generally, the conventional methods and devices for inputting information to portable electronic devices such as mobile phones and PDAs are inconvenient and susceptible to error.

### SUMMARY OF INVENTION

It is therefore a primary objective of the present invention to provide a convenient and dynamic method for defining functions of keys of a keypad of an electronic device to solve the aforementioned problems of the prior art.

Briefly summarized, a method according to the present invention includes storing a standard keypad definition and at least one alternate key definition for at least one key in a memory of the electronic device. The standard keypad definition includes standard key definitions corresponding each key of the keypad to a unique key code, and the alternate key definition corresponds the key to a key code other than that of the standard key definition. The method further includes reading a state of a Boolean flag stored in the memory with a keypad driver, and updating the keypad driver with the alternate key definition of the key when the state of the flag is true, the alternate key definition overwriting the corresponding standard key definition.

According to the present invention, the method can further include toggling the flag between true and false, updating the keypad driver with the standard key definition of the key when the state of the flag is false, the standard key definition overwriting the corresponding alternate key definition.

According to the present invention, the method can further include providing an interchangeable faceplate for the keypad of the electronic device. The interchangeable faceplate has markings corresponding to the keypad definition of the updated keypad driver including the at least one alternate key definition.

It is an advantage of the present invention that multiple keypad definitions can be selected between, providing extended functionality to a finite number of keys.

It is a further advantage of the present invention that the keypad driver and keypad definitions reduce a quantity of application code required for mapping keys.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of a mobile phone according to the present invention.

FIG. 2 is a schematic diagram of a keypad overlay according to the present invention.

FIG. 3 is a flowchart of a method according to the preferred embodiment of the present invention.

### DETAILED DESCRIPTION

The present invention method is described in the following as relating to a mobile phone, however, the method is also applicable to other similar electronic devices that utilize a keypad for input, such as personal digital assistants (PDAs).

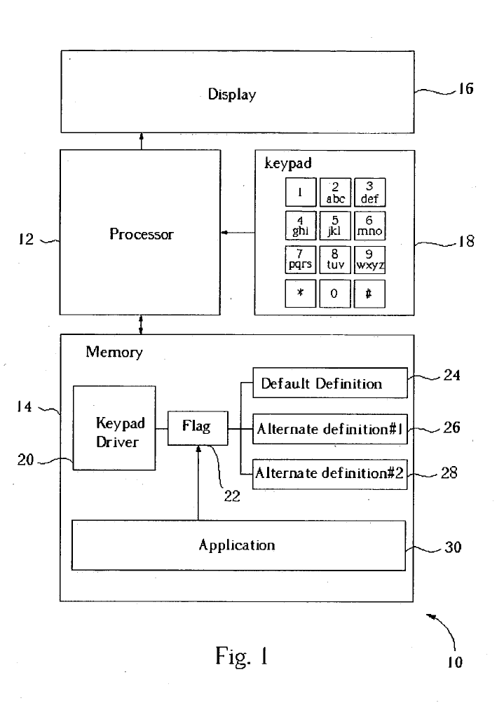

Please refer to FIG. 1. FIG. 1 shows a block diagram of a mobile phone 10. The mobile phone 10 comprises a processor 12, a memory 14 (such as a random-access memory or a flash memory). The mobile phone includes other electronics (not shown), such as digital signal processors and radio transmitters and receivers, for implementing well-known functions of the mobile phone 10 including sending and receiving digital transmissions to and from cellular base stations. The mobile phone further comprises a display 16 for outputting information and a keypad 18 for accepting input. The keypad 18 includes the standard 12 alphanumeric telephone keys as well as several control keys (send, end, clear, etc not shown). The processor 12 controls the display 16 and the keypad 18. A user can view output of the processor 12 on the display 16 and enter information into the mobile phone 10 through the keypad 18. The memory 14 includes all program code necessary for the processor 12 to realize the functions of the mobile phone 10.

According to the present invention, the memory 14 further includes a keypad driver 20 for enabling the processor 12 to control the keypad 18. A flag 22 is further provided in the memory 14 to allow the processor 12 to direct the keypad driver 20 to select between several keypad definitions depending on a state of the flag 22. The keypad definitions are a standard definition 24, a first alternate definition 26, and a second alternate definition 28. The memory 14 further stores an application 30, such as a short message service text editor, word processor, or spreadsheet. The application 30 is capable of being executed by the processor 12, and responds to input from the keypad 18, outputting to the display 16 through the processor 12. The application 30 includes instructions to set the state of the flag 22 to either a standard state, a first alternate state, and a second alternate state corresponding to the three key pad definitions 24, 26, and 28. During normal phone 10 operations, that is, when the application 30 is not being executed, the flag 22 is set to the standard state and the keypad driver 20 is loaded with the standard keypad definition 24. When the application 30 is executed, the processor sets the flag 22 state based on the current process of the application 30, and loads the keypad driver 20 with the according keypad definition. In this way, the present invention allows a 12-key keypad to be expanded beyond the 12 physical keys.

The standard definition 24 of the keypad 18 is shown in Table 1, which shows the correlation between key pressed, key code used in the keypad driver 20, and function. This definition is used primarily when the application 30 in not being executed and the flag 22 is set to the standard state. For example, when a user presses the “3” key, the keypad driver outputs a key code “C3” which instructs the processor 12 and related communication software to dial a “3” as part of a telephone number.

| | TALBE 1 | | | | | | | | | | | |
|---|---|---|---|---|---|---|---|---|---|---|---|---|
| | Key | | | | | | | | | | | |
| | 0 | 1 | 2 | 3 | 4 | 5 | 6 | 7 | 8 | 9 | * | # |
| Key | C0 | C1 | C2 | C3 | C4 | C5 | C6 | C7 | C8 | C9 | C10 | C11 |
| code | | | | | | | | | | | | |
| Func- | ”0” | ”1 ” | ”2” | ”3” | ”4” | ”5” | ”6” | ”7” | ”8” | ”9” | ”*” | ”#” |
| tion | | | | | | | | | | | | |

Table 2 shows the first alternate keypad definition 26. Upon execution, the application 30, a spreadsheet will be taken as an example, sets the flag 22 to the first alternate state. The keypad driver 20 is then loaded with the first alternate keypad definition 26. In the example shown in Table 2, cursor and page navigation functions (cursor up/down/left/right and next/previous page), and file save and load functions are provided through first alternate key codes C50-C57.

TABLE 2

| | Key | | | | | | | | | | | |
|---|---|---|---|---|---|---|---|---|---|---|---|---|
| | 0 | 1 | 2 | 3 | 4 | 5 | 6 | 7 | 8 | 9 | * | # |
| Key code | — | C50 | C51 | C52 | C53 | — | C54 | — | C55 | — | C56 | C57 |
| Function | — | Prev. | Up | Next | Left | — | Right | — | Down | — | Save | Load |

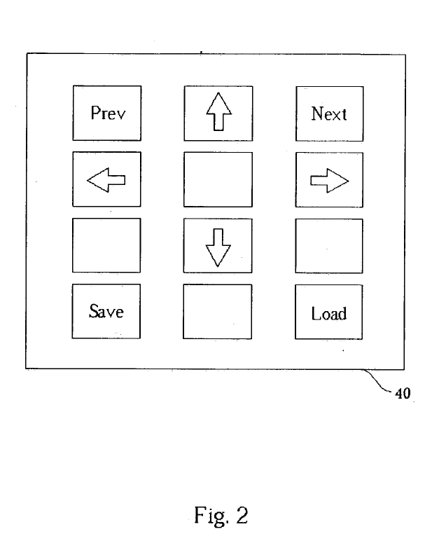

The second alternate keypad definition 26 is set as shown in Table 3. During execution of the application 30, instructions in the application 30 set the flag 22 to the second alternate state. The example shown in Table 3 allows the user to enter numerals “0-9” and further provides save and load keys to the application 30. Both the first and second alternate keypad definitions are conducive to the example of the application 30 being a calculation spreadsheet. Additionally, FIG. 2 illustrates a keypad overlay 40 that can be placed over the keypad so that the user need not memorize the redefined functions of each key. For example, when user controls the application 30 to set the state of the flag 22 to the second alternate keypad definition, the user also overlays the keypad overlay 40 on the keypad 18. Other applications requiring different keypad definitions can be provided with these by the present invention in the same way.

TABLE 3

| | Key | | | | | | | | | | | |
|---|---|---|---|---|---|---|---|---|---|---|---|---|
| | 0 | 1 | 2 | 3 | 4 | 5 | 6 | 7 | 8 | 9 | * | # |
| Key code | C0 | C1 | C2 | C3 | C4 | C5 | C6 | C7 | C8 | C9 | C57 | C58 |
| Function | ”0” | ”1” | ”2” | ”3” | ”4” | ”5” | ”6” | ”7” | ”8” | ”9” | Save | Load |

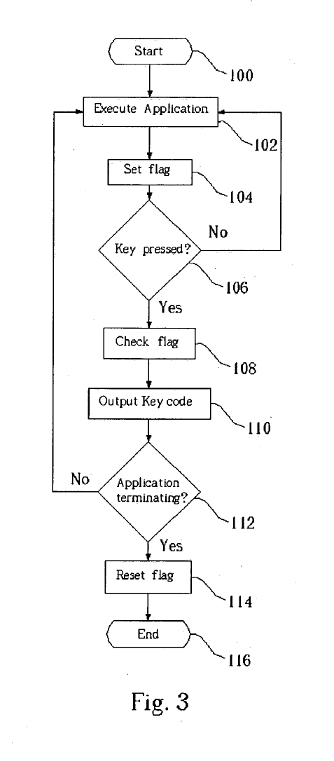

Please refer to FIG. 3, which illustrates a flowchart of a method according to the preferred embodiment of the present invention. The flowchart is described as follows with reference to the mobile phone 10 of FIG. 1.

Step 100: Start;

Step 102: The processor 12, supported by the memory 14, executes application 30. The application 30 determines the input capability of the mobile phone 10, specifically, the capabilities of the keypad 18 and if an external input device is attached;

Step 104: The application 30 sets the flag 22 to select the appropriate keypad definition. The keypad definition is selected by instructions in the application 30, the instructions either originating from the user through the keypad 18 or being preprogrammed. The flag 22 is set to one of the standard, first alternate, or second alternate states;

Step 106: The keypad 18 detects for a key-press. At this time no key code is generated. If a key press is detected go to step 108, if not, return to step 102;

Step 108: The processor 12 detects that a key has been pressed. The keypad driver 20 checks the state of the flag 22;

Step 110: The keypad driver 18 generates and outputs a key code of the current keypad definition as determined by the flag 22 corresponding to the key pressed. The key code is output to the application 30;

Step 112: Is execution of the application 30 to be ended? If the application 30 is being terminated go to step 114, if not, return to step 102;

Step 114: The application 30 sets the flag 22 to the standard keypad definition 24 just in advance of terminating. In this way, subsequently executed applications, including those not programmed to manipulate the state of the flag 22, can utilize the standard keypad definition 24 through the keypad driver 20;

Step 116: End.

The method as described above, assigns key codes at a level lower than the application 30. This means that the application 30 need only internally support its own input system (i.e. the functional response to a range of key codes) and simply demand that the keypad driver 20 supply the required key codes. Additionally, when further input capability, such as an externally attached keyboard, is detected in step 102, the present invention method can set the flag 22 for a keypad definition of this device. Furthermore, the application 30 can be programmed to set the flag dynamically as the user is making use of functionality the application 30, so that the active keypad definition changes depending on input received at the keypad 18.

Generally, the factor limiting the number of keypad definitions is the capacity of the memory 14. Thus, the present invention method supports emulated 101-key standard keyboards or specialized application-dependant input schemes.

In contrast to the prior art, the present invention provides multiple keypad definitions that can be selected between for extending the functionality of a finite number of keys. The quantity of application code for mapping keys is reduced. The present invention is also intuitive for both users of devices having limited keypads and programmers of applications for these devices.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for defining functions of keys of a keypad of an electronic device, the electronic device comprising a processor, a memory, and a keypad driver for receiving input from keypad, the method comprising:
storing a standard keypad definition in the memory, the standard keypad definition comprising standard key definitions corresponding each key of the keypad to a unique key code;
storing at least one alternate key definition for at least one key in the memory, the alternate key definition corresponding the key to a key code other than that of the standard key definition;
reading a state of a Boolean flag stored in the memory with the keypad driver; and
updating the keypad driver with the alternate key definition of the key when the state of the flag is true, wherein the alternate key definition overwrites the corresponding standard key definition.

2. The method of claim 1 further comprising:
toggling the flag between true and false; and
updating the keypad driver with the standard key definition of the key when the state of the flag is false, wherein the standard key definition overwrites the corresponding alternate key definition.

3. The method of claim 1 further comprising providing an interchangeable faceplate for the keypad of the electronic device, wherein the interchangeable faceplate has markings corresponding to the keypad definition of the updated keypad driver including the at least one alternate key definition.

4. The method of claim 1 wherein the keypad is a standard alphanumeric telephone keypad and the electronic device is a mobile phone.

5. A method for defining functions of keys of a keypad of an electronic device, the electronic device comprising a processor, a memory, and a keypad driver for receiving input from keypad, the method comprising:
storing a standard keypad definition in the memory, the standard keypad definition comprising standard key definitions corresponding each key of the keypad to a unique key code;
executing a program stored in the memory of the electronic device with the processor, the program receiving key codes from the keypad driver;
storing at least one alternate key definition for at least one key in the memory, the alternate key definition corresponding the key to a key code other than that of the standard key definition;
writing a state of a Boolean flag to the memory with the program;
reading the state of the flag stored in the memory with the keypad driver; and
updating the keypad driver with the alternate key definition of the key when the state of the flag is true, wherein the alternate key definition overwrites the corresponding standard key definition.

6. The method of claim 5 further comprising:
toggling the flag between true and false with the program; and
updating the keypad driver with the standard key definition of the key when the state of the flag is false, wherein the standard key definition overwrites the corresponding alternate key definition.

7. The method of claim 6 further comprising outputting key codes from the keypad driver to the program based on the keypad definition indicated by the flag, the outputted key codes corresponding to keys pressed on the keypad.

8. The method of claim 6 further comprising terminating execution of the program while the flag is set to false.

9. The method of claim 5 further comprising providing an interchangeable faceplate for the keypad of the electronic device, wherein the interchangeable faceplate has markings corresponding to the keypad definition of the updated keypad driver including the at least one alternate key definition.

10. The method of claim 5 wherein the keypad is a standard alphanumeric telephone keypad and the electronic device is a mobile phone.

11. A method for defining functions of a plurality of keys of a keypad of an electronic device, the electronic device comprising a processor, a memory, and a keypad driver for receiving input from keypad, the method comprising:
storing a standard keypad definition in the memory, the standard keypad definition corresponding the plurality of keys of the keypad to a standard key code set;
executing a program stored in the memory of the electronic device with the processor, the program receiving key codes from the keypad driver;
storing a plurality of alternate keypad definitions in the memory, each alternate keypad definition corresponding the plurality of keys to a different key code set;
toggling a flag between alternate states and a standard state with the program, wherein the alternate states correspond to the alternate keypad definitions and the standard state corresponds to the standard keypad definition; and
updating the keypad driver with the keypad definition corresponding to the state of the flag, wherein the updated keypad definition overwrites a previous keypad definition.

12. The method of claim 11 further comprising terminating execution of the program while the flag is set to the standard state.

13. The method of claim 111 further comprising outputting key codes from the keypad driver to the program based on the keypad definition indicated by the flag, the outputted key codes corresponding to keys pressed on the keypad.

14. The method of claim 11 further comprising providing a plurality of interchangeable faceplates for the keypad of the electronic device, wherein each interchangeable faceplate has markings corresponding to the each alternate keypad definition.

15. The method of claim 11 wherein the keypad is a standard alphanumeric telephone keypad and the electronic device is a mobile phone.
